(19) United States
(12) Patent Application Publication
(10) Pub. No.: US 2025/0145459 A1
(43) Pub. Date: May 8, 2025

(54) REFORMING WITH CARBON CAPTURE

(71) Applicant: ZoneFlow Reactor Technologies, LLC, Windsor, CT (US)

(72) Inventor: Jonathan Jay Feinstein, Windsor, CT (US)

(21) Appl. No.: 18/837,159

(22) PCT Filed: Feb. 22, 2023
(86) PCT No.: PCT/US2023/063056

§ 371 Date: Aug. 8, 2024

Related U.S. Application Data
(60) Provisional application No. 63/312,841, filed on Feb. 23, 2022.

(51) Int. Cl. C01B 3/38; B01D 53/047; B01D 53/14; B01D 53/62; B01D 53/78; C01B 3/48; C01B 3/52; C01B 3/56

(52) U.S. Cl. CPC C01B 3/382; B01D 53/047; B01D 53/1475; B01D 53/62; B01D 53/78; C01B 3/48; C01B 3/52; C01B 3/56; B01D 2252/204; B01D 2256/16; B01D 2257/502; B01D 2257/504; C01B 2203/0233; C01B 2203/0283; C01B 2203/0415; C01B 2203/042; C01B 2203/047; C01B 2203/0475; C01B 2203/1235

(57) ABSTRACT

Steam reforming processes can include treatment of syngas by water gas shift, water separation, and hydrogen separation by pressure swing adsorption (PSA). Additionally, CO₂ can be scrubbed from the syngas prior to the PSA. PSA tail gas, including CH₄, CO, and H₂, can be recompressed and recycled to the PSA for further hydrogen separation and to the steam reformer feed to convert eventually all carbon in the feedstock into CO₂ for the scrubber to separate. Fuel requirements can be fulfilled by part of the hydrogen product to eliminate stack CO₂ emissions.

### CROSS-REFERENCE TO RELATED APPLICATIONS

This application claims the benefit of U.S. Provisional Application Ser. No. 63/312,841, filed Feb. 23, 2022, titled REFORMING WITH CARBON CAPTURE, which is incorporated by reference herein in its entirety.

### FIELD

The present disclosure relates to systems and methods for the production of hydrogen by reforming.

### SUMMARY

In a first aspect, a method of producing hydrogen comprises reforming a mixture of a steam and a feedstock containing carbon and hydrogen in a steam reforming unit to produce syngas comprising hydrogen, carbon dioxide, and at least one of methane and carbon monoxide; separating the syngas in at least one separation unit into a carbon dioxide rich stream, a hydrogen rich stream, and a tail gas stream containing remaining contents of the syngas; and converting at least a portion of the tail gas stream to hydrogen and carbon dioxide.

In some embodiments, the at least a portion of the tail gas is recycled to the steam reforming unit wherein the at least a portion of the tail gas is converted to hydrogen and carbon dioxide. In some embodiments, nitrogen is separated from the at least a portion of the tail gas before the at least a portion of the tail gas is recycled to the steam reforming unit.

In some embodiments, water is separated from the syngas in a water separator to produce an outlet stream of water and a stream containing remaining contents of the syngas entering the water separator.

In some embodiments, at least a portion of the hydrogen rich stream is used as a combustion fuel for the steam reforming unit. In some embodiments, the at least a portion of the hydrogen rich stream is turbo-expanded to perform work before being used as the combustion fuel. In some embodiments, a temperature of the at least a portion of the hydrogen rich stream is increased by at least 50° C. before being turbo-expanded.

In some embodiments, the carbon dioxide rich stream is separated from the syngas in a carbon dioxide separation unit, wherein the hydrogen rich stream is separated from remaining syngas in a hydrogen separation unit having the hydrogen rich outlet stream and the tail gas outlet stream, and wherein at least a portion of the tail gas stream from the hydrogen separation unit is compressed and fed into the hydrogen separation unit to separate additional hydrogen from the tail gas.

In a second aspect, a method of producing hydrogen comprises reforming a mixture of a steam and a feedstock containing carbon and hydrogen in a steam reforming unit to produce syngas comprising hydrogen, carbon dioxide, and at least one of methane and carbon monoxide; separating the syngas in at least one separation unit into at least a hydrogen rich stream and a tail gas stream comprising at least hydrogen and one or more of carbon dioxide, methane, and carbon monoxide; and recycling at least a portion of the tail gas stream into the steam reforming unit.

In some embodiments, recycling the at least a portion of the tail gas stream comprises mixing the at least a portion of the tail gas stream with the mixture of the steam and the feedstock in a line connected to the steam reforming unit.

In some embodiments, flue gases generated by the method do not contain carbon dioxide.

In some embodiments, a portion of the hydrogen rich stream is used as a combustion fuel for the steam reforming unit. In some embodiments, the portion of the hydrogen rich stream used as a combustion fuel comprises at least 40% of hydrogen entering the at least one separation unit.

In some embodiments, the method further comprises recompressing and recycling a portion of the tail gas stream into the at least one separation unit.

In some embodiments, the tail gas stream comprises at least one of carbon monoxide and methane. In some embodiments, the recycling causes carbon in the at least one of carbon monoxide and methane in the tail gas to be converted to carbon dioxide in the steam reforming unit. In some embodiments, the at least one separation unit comprises at least a carbon dioxide scrubber, and wherein carbon dioxide removed from the syngas at the carbon dioxide scrubber is sequestered. In some embodiments, any carbon compounds not removed from the syngas at the carbon dioxide scrubber are included in the at least a portion of the tail gas recycled into the steam reforming unit.

In a third aspect, a method of producing hydrogen comprises reforming a mixture of a steam and a feedstock containing carbon and hydrogen in a reforming unit to produce syngas comprising hydrogen, carbon dioxide, and at least one of methane and carbon monoxide; separating the syngas in at least one separation unit into a carbon dioxide rich stream, a hydrogen rich stream, and a tail gas stream containing remaining contents of the syngas; and reforming the tail gas stream to produce additional hydrogen.

In some embodiments, the method further comprises combusting at least a portion of the hydrogen rich stream as fuel for combustion heating.

In some embodiments, the tail gas stream contains less than 40% hydrogen.

In some embodiments, the tail gas stream contains less than 10% carbon monoxide.

In some embodiments, the tail gas stream contains at least 10% methane.

In some embodiments, water is separated from the syngas in a water separator to produce an outlet stream of water and a stream containing remaining contents of the syngas entering the water separator.

In some embodiments, at least a portion of the hydrogen rich stream is used as a combustion fuel for the steam reforming unit.

In some embodiments, the at least a portion of the hydrogen rich stream is turbo-expanded to perform work before being used as the combustion fuel.

In some embodiments, a temperature of the at least a portion of the hydrogen rich stream is increased by at least 50° C. before being turbo-expanded.

In some embodiments, the carbon dioxide rich stream is separated from the syngas in a carbon dioxide separation unit, wherein the hydrogen rich stream is separated from remaining syngas in a hydrogen separation unit having the hydrogen rich outlet stream and the tail gas outlet stream, and wherein at least a portion of the tail gas stream from the hydrogen separation unit is compressed and fed into the hydrogen separation unit to separate additional hydrogen from the tail gas.

### BRIEF DESCRIPTION OF THE DRAWINGS

FIG. 1 schematically illustrates an example hydrogen production unit in accordance with the present technology.

FIG. 2 schematically illustrates an example hydrogen production unit in accordance with the present technology.

FIG. 3 schematically illustrates an example hydrogen production unit in accordance with the present technology.

### DETAILED DESCRIPTION

Reforming processes include reacting a hydrocarbon with steam and/or carbon dioxide over a catalyst to produce syngas, a mixture of hydrogen and oxides of carbon. The hydrogen content of the syngas is often increased by cooling the syngas and reacting it over a catalyst to convert some of its carbon monoxide and remaining water vapor to additional hydrogen and carbon dioxide. A final treatment is to separate the hydrogen product from the remainder of the syngas comprised of steam, CH₄, CO, and CO₂. The steam is condensed and separated by cooling the syngas and passing the resulting two-phase mixture through a gas-liquid separator. Hydrogen is then separated in a pressure swing adsorption (PSA) unit containing a molecular sieve, resulting in a high pressure outlet stream containing approximately 90% of the inlet hydrogen at greater than 99% purity and a low pressure outlet stream of “tail gas” comprising the remaining H2, and CH₄, CO, and CO₂ constituents of the inlet syngas to the PSA unit.

The fuel value of the low-pressure tail gas is conveniently used to fulfill a large portion of low-pressure burner fuel requirements for heating the reformer. The process provides extremely high purity hydrogen used as a reactant in other processes. Conventional steam reforming processes are not effective, however, for lowering undesirable CO₂ emissions to the atmosphere of hydrocarbons used as fuels for heating or power generation compared to the emissions of burning the inlet feedstock.

CO₂ may be scrubbed from a gas mixture such as flue gas from combustion furnaces and electric power plants by which the CO₂ portion of a gas preferentially dissolves in a solvent or forms chemical or physical bonds with a liquid. Such methods include the cycling of the gas to be scrubbed between a low and/or high temperature or high- and low-pressure baths of amines, ammonia, hydroxides, or the like. Other methods of isolating CO₂ from other gas species include distillation and adsorption.

Although conventional CO₂ separation methods exist, they are not suitable for removing the CH₄ and CO components of the tail gas which is combusted to heat the reformer. Thus, conventional CO₂ separation methods still result in substantial CO₂ stack emissions. Removal of dilute CO₂ from a stack at atmospheric pressure is less effective and more expensive than its removal from a high concentration of CO₂ in a gas at high pressure.

It would be desirable to produce hydrogen by the relatively inexpensive steam reforming process while also capturing a high portion and preferably all the carbon contained in the feedstock in order to lower and preferably eliminate CO₂ emissions to the environment. In systems described herein, the carbon components of the feedstock are not exhausted to the atmosphere, but rather can be removed at high pressure as CO₂. This technology can prevent carbon emissions from a steam reformation facility. Other objectives of the present technology will be observed by one reasonably skilled in the art.

Conventional steam methane reforming (SMR) wisdom is to make as much hydrogen product for export as possible from a plant of a given size, to process the process gases no more than one time, and to burn all of the carbon entering the plant to provide heat for the reforming process. In contrast, the present technology substantially reduces or eliminates carbon emissions by departing from this conventional practice in some or all respects. Whereas about 89% of the hydrogen produced in the reformer is recovered as product hydrogen for export in conventional practices of SMR and PSA hydrogen production (with the other 11% being inseparable from the fuel used for heating), the present technology utilizes approximately 43% of the hydrogen produced in the reformer to be intentionally combusted for heating purposes. Accordingly, approximately 57% of the hydrogen at high purity is recovered as product hydrogen for export in embodiments of the present technology. This in turn entails the novel and counterintuitive consumption of some of the purified PSA hydrogen as fuel and the recycling of carbon (in the form of PSA tail gas) from the syngas to the reformer feedstock rather than combusting carbon in the SMR furnace or scrubbing carbon from flue and/or exhaust gasses. This sacrificial combustion of fully refined hydrogen product is non-intuitive to one skilled in the art. However, by the discretionary use of hydrogen as fuel, by recycling PSA tail gas to the reformer mixed feed, and by forgoing the combustion of carbon to heat the reforming process, the present technology differs substantially from the strategy and methods of conventional SMR processes and reduces or eliminates carbon emissions.

Mixed feed of steam or oxygen and a hydrocarbon or other feedstock containing hydrogen or hydrogen and carbon is reformed over a catalyst to form a syngas. In some embodiments the syngas undergoes the following three separations. First, steam is separated from the syngas, preferably in a separate process by condensation of the steam followed by phase separation of condensed water from the syngas, producing a water outlet stream and a stream of the remaining syngas. Second, carbon dioxide is separated from the syngas, preferably in a separate process and preferably by preferential dissolution of carbon dioxide in a solvent such as an amine, producing a carbon dioxide rich outlet stream and a stream of the remaining syngas. Third, hydrogen is separated from the syngas, preferably in a separate process and preferably by PSA, producing a high-pressure outlet stream of enriched hydrogen and a low-pressure outlet stream (e.g., a tail gas stream) containing the remaining components of the syngas. The separations of water, carbon dioxide, and hydrogen may be performed in any sequence, combination, or subcombination, and by any alternative processes. In some embodiments, water is separated first, and hydrogen is separated last, such that the tail gas from the PSA unit contains substantial volume percentages of methane, carbon monoxide, and hydrogen, and nominal or trace volume percentages of steam and carbon dioxide. For example, in some embodiments the tail gas may be less than 1% steam and less than 5% CO₂ by volume.

In some embodiments, the carbon dioxide rich outlet stream is at least 90% pure carbon dioxide. In some embodiments, the carbon dioxide rich outlet stream contains at least 80%, 85%, 90% or 95%, and preferably at least 92%, of the carbon dioxide contained in the syngas stream from which it was separated.

In some embodiments, the high-pressure outlet stream of enriched hydrogen contains at least 90% or at least 99% pure hydrogen. In some embodiments, the high-pressure outlet stream of enriched hydrogen contains at least 80% or at least 90% of the hydrogen molecules contained in the steam from which it was separated.

The carbon dioxide outlet stream exits the process and may be sequestered or used for some purpose such as a chemical reactant or addition or to enhance the recovery of subterranean oil or natural gas.

In some embodiments, the hydrogen rich stream from the PSA unit is separated into a first hydrogen stream used as a combustion fuel, such as for heating the reforming furnace, and a second hydrogen stream that is exported or used as a product for a purpose outside the steam reforming unit. “Export,” in this context, can mean to expel the second hydrogen stream from the hydrogen production unit. Exported streams may be used for a purpose outside the hydrogen production unit or stored or sequestered. In some embodiments, the first and second hydrogen streams may have different nitrogen contents, which may be achieved by timing their respective withdrawals from the PSA unit. Nitrogen may be purged from the system via the first hydrogen stream used as fuel.

The first hydrogen stream may be turbo-expanded prior to entering the reforming furnace as a fuel. The first hydrogen stream may also be raised in temperature (e.g., by at least 50° C. and in some embodiments to at least 300° C. or at least 800° C.) prior to turbo-expansion at a temperature which may be less than 300° C. The turbo-expander may also perform useful work such as to drive a compressor or turn an electric generator, etc. The hydrogen may be expanded in multiple stages of alternating reheating and further expansion.

In some embodiments, the tail gas containing CH₄, CO, and H₂ is compressed and used as a feedstock in a steam reforming unit, such as the reforming unit described above.

It was discovered by modelling various practices that the composition of the tail gas recycled to the reformer may determine the effectiveness of this art in ways and to extents not previously expected. The separation of syngas into a hydrogen rich steam and a tail gas stream containing the remaining constituents of the syngas without additional separation steps may not provide a tail gas composition appropriate for the improved efficiency of the present art in terms of low incremental costs of hydrogen production per unit of carbon dioxide emissions captured or avoided.

In some embodiments, tail gas from a hydrogen PSA unit is further processed to remove hydrogen from the tail gas stream to make the composition of tail gas acceptable for recycle to the reformer feedstock and more effective than the prior methods.

In some embodiments, a distillation unit is used to separate syngas into a hydrogen rich stream, a carbon dioxide rich stream and a tail gas stream of the remaining syngas contents of suitable composition for recycle to the reformer feedstock.

In some embodiments, syngas is separated into a first hydrogen rich stream and the remaining syngas, the remaining syngas is reacted in a water gas shift reactor to convert additional steam and CO to H₂ and CO₂, the shifted syngas is separated into a carbon dioxide rich stream, a second hydrogen rich stream, and a tail gas stream containing the remaining contents of the shifted syngas. The first hydrogen rich steam may be separated by a membrane. The second separation may be by distillation. The first and second hydrogen rich streams may be used as fuel to heat the reformer and as a hydrogen product for export. These novel combinations of separation processes can provide tail gas compositions for the improved functionality as recycled feedstock to the reformer.

One example method of controlling the composition of the recycle stream is to control the recovery hydrogen to one or more hydrogen rich streams and to control the recovery of CO₂ to the CO₂ rich stream. One example method of lowering the CO content of the recycle stream is to enhance the water gas shift reaction by removing hydrogen from the syngas upstream of the water gas shift reactor.

In some embodiments the stream recycled to the feedstock in the reforming unit contains less than 30% hydrogen or less than 10% carbon monoxide or at least 10% methane. The recycle stream preferably contains less than 30% or 20% or 10% hydrogen or less than 5% carbon monoxide or at least 15% methane. The tail gas most preferably contains at least 40% methane, less than 2% CO, less than 2% CO₂, and less than 2% H₂.

In some embodiments, the tail gas stream is compressed and conveyed to a PSA unit, such the PSA unit described above, wherein hydrogen is separated from the other contents of the tail gas.

In some embodiments, the tail gas is compressed and divided into a first tail gas stream used as feed to a reformer and a second tail gas stream fed to a PSA unit for separation of hydrogen from the other contents of the second tail gas stream. The first tail gas stream can be used to purge the CH₄ and CO content of the syngas and tail gas. The second tail gas stream can be used to increase the recovery of hydrogen from the tail gas.

In some embodiments, nitrogen undesirably introduced with the feedstock is separated and purged from the second tail gas stream. For example, the second tail gas stream may be compressed and then subjected to membrane separation wherein nitrogen is retained by the membrane and H₂, CH₄, and CO permeate the membrane at a pressure suitable for entry into the reformer as feedstock.

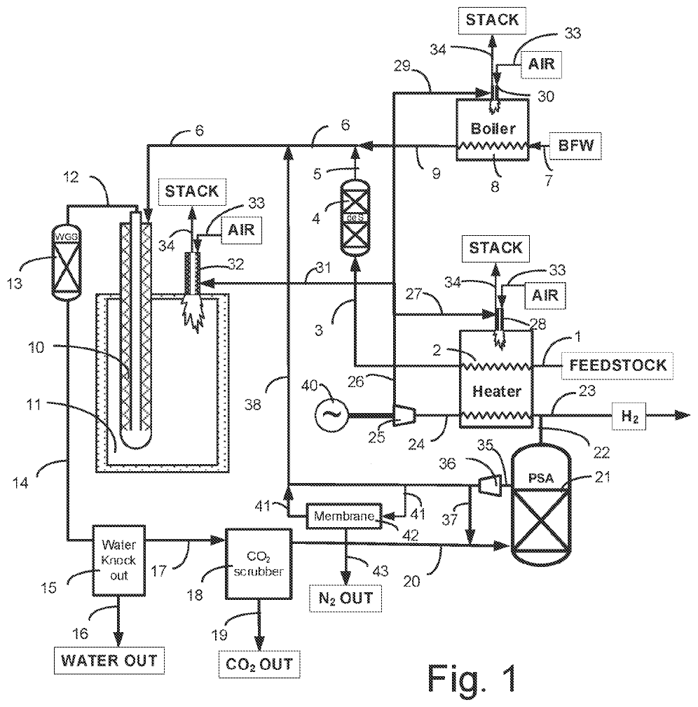

Referring now to FIG. 1, an example hydrogen production unit implementing carbon capture aspects of the present technology will be described. As shown in FIG. 1, line 1 conveys a hydrocarbon feedstock to a heater 2. Within the heater 2, the feedstock can be preheated to a temperature suitable for desulfurization. The preheated feedstock is conveyed by line 3 from the heater 2 to a desulfurization unit 4 wherein the feedstock is desulfurized. Line 5 conveys the desulfurized feedstock from desulfurization unit 4 to line 6 carrying steam, wherein the feedstock mixes with the steam in line 6. Line 7 conveys boiler feed water to a boiler 8 wherein the boiler feed water is raised to steam. Line 9 conveys the steam from the boiler 8 to line 6 wherein the steam mixes with the feedstock from line 5 to form a mixed feed. Line 6 conveys the mixed feed to a reforming reactor tube 10 wherein the mixed feed is heated and converted over a catalyst to a syngas containing H₂, CH₄, CO, CO₂, and steam. Reforming reactor tube 10 resides at least partially within, and is heated by, a furnace 11. Line 12 conveys the syngas from the reforming reactor tube 10 to a water gas shift (WGS) unit 13 wherein some of the CO and steam in the syngas react to form additional H₂ and CO₂. The syngas may be cooled from its peak temperature within the reforming reactor tube 10 to a lower temperature in line 12 and in WGS unit 13 via heat exchange against mixed feed within a bayonet reforming reactor tube 10 as shown, or via other forms of heat exchangers or coolers. Line 14 conveys the shifted syngas from the WGS unit 13 to a water knockout unit 15 wherein the syngas is cooled, some of the steam condenses to water from the syngas, and the condensed water is separated from the remaining syngas and exits via line 16. Line 17 conveys the syngas from the water knockout unit 15 to a carbon dioxide scrubber 18 wherein carbon dioxide is dissolved in an amine solvent at a first temperature and the solvent is isolated from the syngas and heated to a second temperature at which carbon dioxide comes out of solution in gaseous state. Optionally, a distillation unit may be employed in place of the carbon dioxide scrubber 18. The separated CO₂ exits via line 19. The separated carbon dioxide may be exported and/or may be further compressed for a specific use or for sequestration. The syngas in the carbon dioxide scrubber 18 may be at a pressure of greater than 10 bar. The carbon dioxide may be expelled at a pressure greater than 10 bar and preferably 30-60 bar.

Line 20 conveys syngas from the scrubber to a pressure swing adsorption (PSA) unit 21. Within the PSA unit 21, about 90% of the hydrogen (e.g., 89%) is separated from the remaining constituents of the syngas. Line 22 conveys high purity, high pressure hydrogen from the PSA unit 21 to line 23, and can be separated into 2 streams, for example, into lines 23 and 24. In some embodiments, the hydrogen in line 23 can be exported as product. In some embodiments, line 24 conveys a portion of the hydrogen from line 22 through the heater 2 wherein the hydrogen is heated (e.g., to at least 300° C. and in some embodiments to at least 800° C.) and then conveyed to a turbo-expander 25 wherein the hydrogen expands and performs work. In some embodiments, the line 24 can carry about 40% of the hydrogen in line 22 form the PSA unit 21. In some embodiments, the line 24 can advantageously carry about 43% of the hydrogen in line 22. One of skill in the art, guided by this disclosure, will understand that the amount of the hydrogen product from line 22 can be varied as required to meet operational requirements. The turbo-expander 25 may provide power to turn an electric generator 40, for example. Line 26 conveys at least a portion of the expanded hydrogen from the turbo-expander 25 to line 27 and a regenerative burner 28 of the heater 2. Line 26 also conveys at least a portion of the expanded hydrogen from the turbo-expander 25 to line 29 and a regenerative burner 30 of the boiler 8. Line 26 further conveys at least a portion of the expanded hydrogen from the turbo-expander 25 to line 31 and a regenerative burner 32 of the furnace 11. Each of the said regenerative burners can be fed air by a line 33 and can exhaust cooled flue gas via line or stack 34.

Line 35 conveys low pressure tail gas from the PSA unit to a compressor 36 wherein the low pressure tail gas is compressed. As discussed above, the tail gas may include the remaining H2, CH₄, CO, and CO₂ constituents of the inlet syngas. Line 38 conveys the compressed tail gas from the compressor 36 to line 6, wherein the compressed tail gas mixes with the other mixed feed to be reformed in the reforming reactor tube 10. Thus, as described herein, the carbon-rich tail gas can be recycled as a portion of the mixed feed to be reformed rather than being emitted, thus reducing or eliminating carbon emissions (e.g., CH₄, CO, and/or CO₂ emissions). Recycling carbon-rich tail gas can require a larger reforming reactor tube 10 than in conventional systems.

In some embodiments, line 41 may convey a portion of the compressed tail gas in line 38 through a membrane unit 42 and back to line 38 and to line 6 wherein the tail gas mixes with mixed feed and is conveyed into reformer tube 10. The membrane unit 42 can separate and purge some nitrogen introduced in the feedstock in line 1 from the tail gas. The purged nitrogen exits via line 43. Line 37 may convey some of the compressed tail gas from the compressor to line 20, which conveys it into the PSA unit 21 for additional hydrogen separation from the syngas.

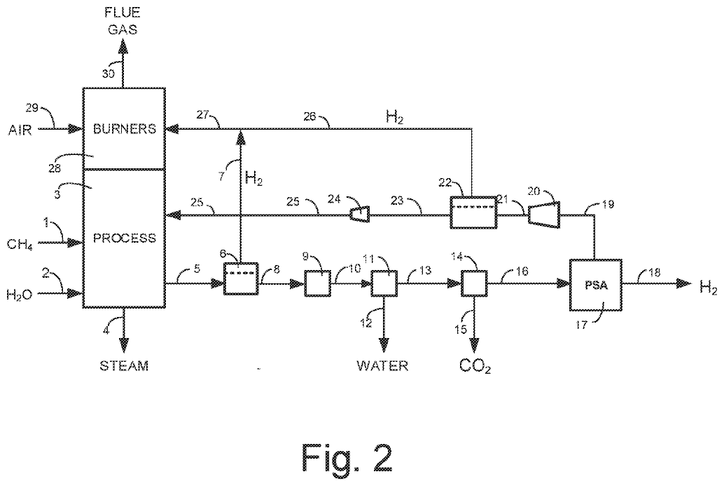

Referring now to FIG. 2, a further example hydrogen production unit implementing carbon capture aspects of the present technology will be described. Line 1 conveys a hydrocarbon feedstock to steam methane reforming unit 3, and line 2 conveys boiler feed water to unit 3 wherein the feedstock and water are heated, reformed over a catalyst, and cooled against some of the boiler feed water to form a stream of steam 4 and a syngas stream 5 containing H₂, CH₄, CO, CO₂, N₂, and steam. Line 4 conveys the stream of steam from unit 3. Line 5 conveys the syngas from unit 3 to hydrogen separation unit 6 wherein some of the hydrogen is separated from the balance of the syngas. Unit 6 may be any type of separation unit, including a membrane consisting of an alloy of palladium operating at a temperature between 200° C. and 500° C. Line 7 conveys a hydrogen rich stream from unit 6 to line 27 wherein it mixes with a second hydrogen rich stream 26. Line 8 conveys the balance of the syngas from unit 6 to water gas shift reactor 9 wherein the syngas reacts over a catalyst to form additional hydrogen and carbon dioxide. The shifted syngas is conveyed by line 10 from reactor 9 through a cooling unit (not shown) wherein the shifted syngas is cooled and some of its steam condenses to water and on to separation unit 11 wherein the condensed water is separated from the shifted syngas. Line 12 conveys the condensed water from unit 11. Line 13 conveys the dehumidified syngas from unit 11 to carbon dioxide separation unit 14 wherein carbon dioxide is separated from the dehumidified syngas. Unit 14 may be a fractional distillation column wherein carbon dioxide is liquefied. An additional line may convey high purity hydrogen from line 7 to unit 14 wherein the hydrogen provides fuel energy for the operation of unit 14. Line 15 exports the carbon dioxide from unit 14 to a sequestration site. Line 16 conveys the remaining components of the syngas from unit 14 to pressure swing adsorption (PSA) unit 17 wherein a high purity hydrogen stream is separated from the balance of the syngas. Line 18 exports the high purity hydrogen from unit 17 to a use point. The syngas in stream 16 may contain nitrogen or other inert gases. PSA unit 17 is operated to vent some of the nitrogen and inert components with the hydrogen in stream 18 or in a third outlet high- or low-pressure stream from PSA unit 17. Line 19 conveys the remaining syngas or tail gas from unit 17 to compressor 20 wherein the tail gas is compressed. Line 21 conveys the tail gas from compressor 20 to hydrogen separation unit 22 wherein hydrogen is separated from the tail gas. For example, unit 22 may consist of one or more membranes in stages to recover a high percentage of the hydrogen as a permeate at high purity. Unit 22 may be a distillation column. Line 23 conveys a stream consisting mostly of CH₄, CO, and CO₂ with lesser amounts of H₂, N₂, and other inert components from unit 22 to compressor 24 wherein it is compressed. Line 25 conveys the compressed stream from compressor 24 to reforming unit 3 wherein it is reformed along with streams 1 and 2 over a catalyst to form syngas. Line 26 conveys a hydrogen rich stream from unit 22 to line 27 wherein it mixes with hydrogen from stream 7. Line 27 conveys the hydrogen from lines 7 and 26 to burner and furnace system 28. Line 29 conveys air to system 28 wherein it combusts with hydrogen from line 27 to heat reformer unit 3. Line 30 conveys combustion products from system 28 from the combustion of the air and hydrogen.

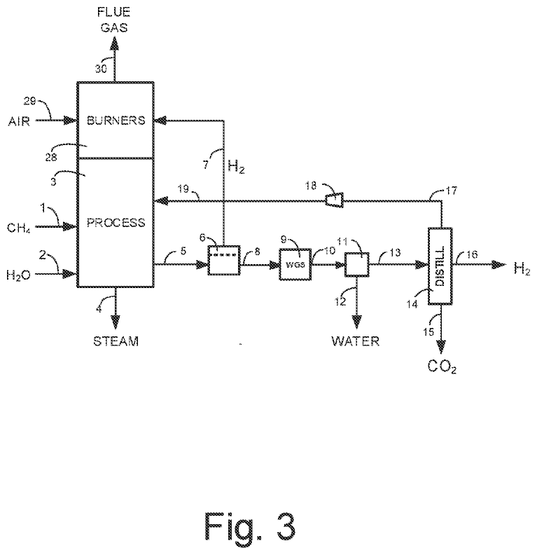

Referring now to FIG. 3, a further example hydrogen production unit implementing carbon capture aspects of the present technology will be described. Line 1 conveys a hydrocarbon feedstock to steam methane reforming unit 3, and line 2 conveys boiler feed water to unit 3 wherein the feedstock and water are heated, reformed over a catalyst, and cooled against some of the boiler feed water to form a stream of steam 4 and a syngas stream 5 containing H₂, CH₄, CO, CO₂, N₂, and steam. Line 4 conveys the stream of steam from unit 3. Line 5 conveys the syngas from unit 3 to hydrogen separation unit 6 wherein some of the hydrogen is separated from the balance of the syngas.

Unit 6 may be any type of separation unit, including a membrane consisting of an alloy of palladium operating at a temperature between 200° C. and 500° C. Line 7 conveys a hydrogen rich stream from unit 6 to combustion system 28 wherein the hydrogen is combusted with air to heat unit 3. Line 8 conveys the balance of the syngas from unit 6 to water gas shift reactor 9 wherein the syngas reacts over a catalyst to form additional hydrogen and carbon dioxide. The shifted syngas is conveyed by line 10 from reactor 9 through a cooling unit wherein the shifted syngas is cooled and some of its steam condenses to water and on to separation unit 11 wherein the condensed water is separated from the shifted syngas. Line 12 conveys the condensed water from unit 11. Line 13 conveys the dehumidified syngas from unit 11 to separation unit 14 wherein carbon dioxide and hydrogen are separated from the dehumidified syngas.

Unit 14 may be a fractional distillation column wherein carbon dioxide is liquefied. Line 15 exports the carbon dioxide from unit 14 to a sequestration site. Line 16 conveys hydrogen product from unit 14. Line 17 conveys the remaining components of the syngas from unit 14 to compressor 18 wherein the remaining components are compressed. Line 19 conveys the compressed remaining components from compressor 18 to unit 3 wherein they are reformed along with streams 1 and 2 over a catalyst to form syngas. Line 29 conveys air to system 28 wherein the air combusts with hydrogen from line 7 to heat reformer unit 3. Line 30 conveys from system 28 combustion products of the air and hydrogen.

Other advantages and other embodiments of the current invention will be obvious to those skilled in the art. Their omission here is not intended to exclude them from the claims advanced herein.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this disclosure. Furthermore, not all the features, aspects and advantages are necessarily required to practice the present technology. Thus, while the above detailed description has shown, described, and pointed out novel features of the present technology as applied to various embodiments, it will be understood that various omissions, substitutions, and changes in the form and details of the apparatus or process illustrated may be made by those of ordinary skill in the technology without departing from the spirit or scope of the present disclosure. The present technology may be embodied in other specific forms not explicitly described herein. The embodiments described above are to be considered in all respects as illustrative only and not restrictive in any manner.

What is claimed is:

1. A method of producing hydrogen, the method comprising:
reforming a mixture of a steam and a feedstock containing carbon and hydrogen in a reforming unit to produce syngas comprising hydrogen, carbon dioxide, and at least one of methane and carbon monoxide;
separating the syngas in at least one separation unit into a carbon dioxide rich stream, a hydrogen rich stream, and a tail gas stream containing remaining contents of the syngas; and
reforming the tail gas stream to produce additional hydrogen.

2. The method of claim 1, further comprising combusting at least a portion of the hydrogen rich stream as fuel for combustion heating.

3. The method of claim 1, wherein the tail gas stream contains less than 40% hydrogen.

4. The method of claim 1, wherein the tail gas stream contains less than 10% carbon monoxide.

5. The method of claim 1, wherein the tail gas stream contains at least 10% methane.

6. The method of claim 1, wherein water is separated from the syngas in a water separator to produce an outlet stream of water and a stream containing remaining contents of the syngas entering the water separator.

7. The method of claim 1, wherein at least a portion of the hydrogen rich stream is used as a combustion fuel for the steam reforming unit.

8. The method of claim 7, wherein the at least a portion of the hydrogen rich stream is turbo-expanded to perform work before being used as the combustion fuel.

9. The method of claim 8, wherein a temperature of the at least a portion of the hydrogen rich stream is increased by at least 50° C. before being turbo-expanded.

10. The method of claim 1, wherein the carbon dioxide rich stream is separated from the syngas in a carbon dioxide separation unit, wherein the hydrogen rich stream is separated from remaining syngas in a hydrogen separation unit having the hydrogen rich outlet stream and the tail gas outlet stream, and wherein at least a portion of the tail gas stream from the hydrogen separation unit is compressed and fed into the hydrogen separation unit to separate additional hydrogen from the tail gas.
